(19) United States
(12) Patent Application Publication
(10) Pub. No.: US 2026/0150783 A1
(43) Pub. Date: Jun. 4, 2026

(54) Lawn mower

(71) Applicant: Shao’ai Hu, Yongkang (CN)

(72) Inventor: Shao’ai Hu, Yongkang (CN)

(21) Appl. No.: 18/965,943

(22) Filed: Dec. 2, 2024

(51) Int. Cl. A01D 34/90; A01D 34/68; A01D 34/76; A01D 101/00

(52) U.S. Cl. CPC A01D 34/90; A01D 34/68; A01D 34/76; A01D 2034/907; A01D 2101/00

(57) ABSTRACT

The present invention relates to the technical field of lawn mowers, and specifically discloses a lawn mower, comprising a telescopic operating arm and a handle assembly arranged at the rear end of the telescopic operating arm, wherein a control module is arranged in the handle assembly, and the lawn mower is characterized in that: it also comprises a cutting assembly arranged at the front end of the telescopic operating arm; the cutting assembly comprises a shell, a driving motor and a cutting blade, a connecting pipe is arranged at one end of the shell, the connecting pipe is connected to the front end of the telescopic operating arm, a driving motor is arranged in the shell, a circular hole is arranged at the lower end of the shell, a bearing is arranged in the circular hole, a rotating shaft of the driving motor extends from the bearing.

### FIELD OF THE INVENTION

The present application relates to lawn mower technology field. More specifically, the present application relates to lawn mower.

### BACKGROUND

In modern society, there is a growing emphasis on environmental protection and the beautification of ecosystems. This has increased attention and development in various areas, including underwater mechanical equipment, landscaping tools, and energy-saving devices. One notable piece of landscaping equipment is the lawn mower, which plays a vital role in maintaining water bodies' cleanliness and aesthetic appeal by removing surface weeds. Traditional lawn mowers typically employ gear transmission to transfer power through the meshing of gears, which drives the mower's cutting head to operate effectively.

However, this traditional lawn mower has some problems during use, such as easy wear of gears, high maintenance costs, and complex operation. The existing lawn mower technology mainly transmits power through gear transmission to drive the cutting head to work; the main features of this technology are simple structure, easy manufacturing, and maintenance. However, due to the meshing and wear of the gears, the service life of this lawn mower is limited and the maintenance cost is high. In addition, the traditional lawn mower requires manual operation during use, which is complicated to operate and cannot meet the needs of modern society for high efficiency and automation.

Therefore a lawn mower is designed for the above problems.

### SUMMARY

The technical problem to be solved by this application is to overcome the defects of the above-mentioned technology and provide a lawn mower.

A lawn mower, comprising a retractable operating arm and a handle assembly arranged at the rear end of the retractable operating arm, wherein a control module is arranged in the handle assembly, comprising a cutting assembly arranged at the front end of the retractable operating arm.

Wherein the cutting assembly comprises a housing, a driving motor, and a cutting blade; a connecting tube is provided at one end of the housing; the connecting tube is connected to the front end of the retractable operating arm; a driving motor is provided in the housing; a circular hole is provided at the lower end of the housing; a bearing is provided in the circular hole; a rotating shaft of the driving motor extends from the bearing; a cutting blade is detachably provided on the rotating shaft of the driving motor extending from the circular hole; the driving motor can drive the cutting blade to rotate.

The handle assembly comprises a handle, a power assembly, a direct-acting travel switch, a power switch and a locking button; the handle is arranged at the rear end of the retractable operating arm; the power assembly is arranged at the lower end of the handle; an inner tube body is arranged inside the upper end of the handle; the locking button is slidably arranged in the inner tube body; and two ends of the locking button extend from two sides of the handle respectively; an upper notch is arranged at the rear end of the inner tube body; and a limit plate is arranged in the middle of the rear end of the locking button, the limit plate extends from the upper notch, the handle is provided with a switch slot, a power switch is provided in the switch slot, the rear end of the power switch is rotatably connected to the handle, a top plate is provided at the upper front end of the power switch, the top plate cooperates with the limit plate, a direct-acting travel switch is provided above the power switch in the handle, a contact column is provided in the middle of the power switch, the contact column cooperates with the direct-acting travel switch to control the on and off of the power supply.

Wherein a limiting slide groove is provided on one side of the inner tube body in the handle, the limiting slide groove is in communication with the inner tube body, a limiting slider is provided on the inner tube body, the limiting slider and the limiting slide groove are slidably matched to limit the movement of the inner tube body along the limiting slide groove.

Wherein a straight groove is provided at the upper end of the connecting tube, connecting portions are provided on both sides of the straight groove on the connecting tube, and a through hole is provided on the connecting portion.

Wherein the contact position between the housing and the rotating shaft of the driving motor and the bearing is sealed, and the connection position between the bearing and the circular hole is sealed.

The advantages of this application compared with the prior art:
1. Gearless Design: This lawn mower features a gearless design that directly drives the cutting blade through the motor. This eliminates the wear and tear often associated with traditional gears, which enhances the mower's longevity and reduces maintenance costs.
2. Automatic Operation: This lawn mower features an automatic operation mode. When the power switch is turned on, it engages a direct-acting travel switch that allows for a secure power connection. The control module directly manages the operation of the drive motor, enabling the lawn mower to operate automatically. This setup simplifies the operation compared to traditional lawn mowers and enhances work efficiency.
3. Waterproof function: The housing of the mower, the contact position between the drive motor shaft and the bearing, and the connection position between the bearing and the round hole are sealed. The waterproof design allows it to work on the water surface and the cutting component can also be extended underwater for use, expanding its application range in the field of underwater mechanical equipment.
4. Environmental protection and energy saving: This lawn mower adopts an environmental protection and energy saving design. By optimizing the design of the cutting components, the structure is relatively simple, the consumption of accessories is reduced, and environmental pollution is effectively avoided, achieving the goal of environmental protection and energy saving.
5. Gearless head: The head of this mower directly drives the cutting blade through the drive motor. It adopts a gearless design, which can avoid the problem that traditional mowers may cause pollution to the environment, and further improve its environmental performance.

### BRIEF DESCRIPTION OF THE DRAWINGS

FIG. 1 is a side view of the lawn mower;

FIG. 2 is a schematic diagram of the three-dimensional structure of the lawn mower;

FIG. 3 is a top view of the lawn mower;

FIG. 4 is a schematic diagram of the structure of a handle assembly of the lawn mower;

FIG. 5 is a schematic diagram of the internal structure of a handle assembly of the lawn mower;

FIG. 6 is a reference diagram of the disassembled state of a handle assembly of the lawn mower;

FIG. 7 is a cross-sectional view at A-A in FIG. 1;

FIG. 8 is a cross-sectional view at B-B in FIG. 4;

FIG. 9 is a partial enlarged view of C from FIG. 5; and

FIG. 10 is a partial enlarged view of D in FIG. 3.

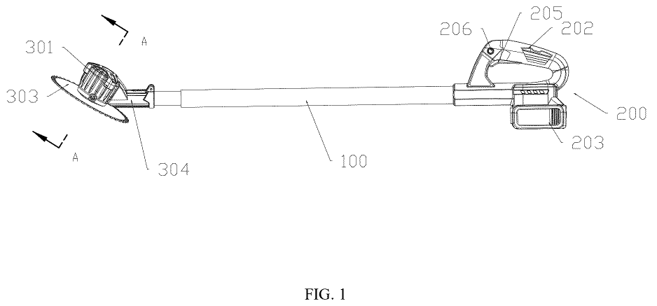

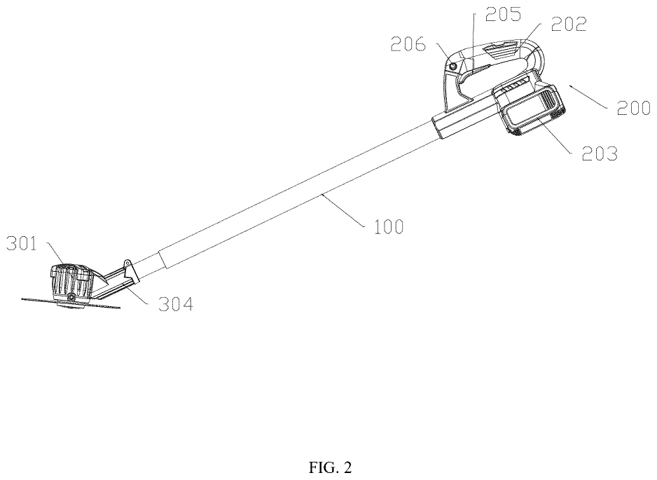

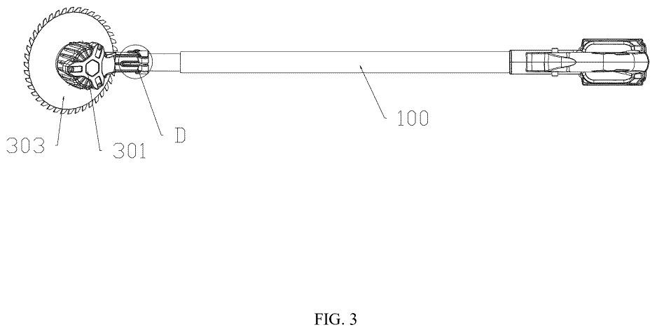

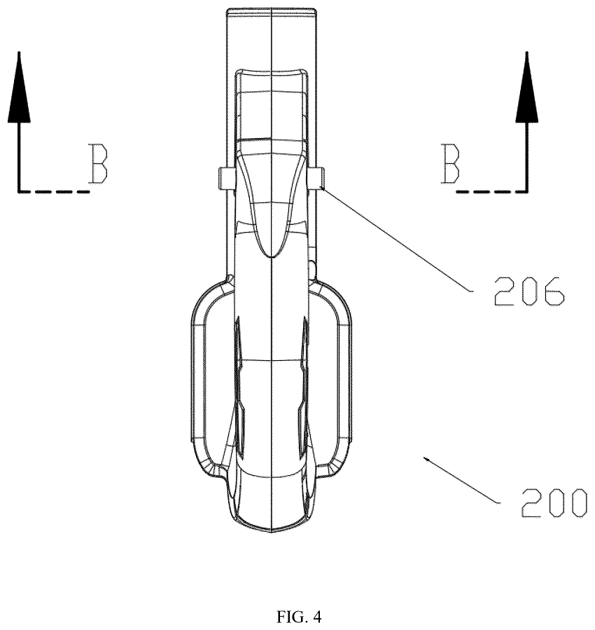

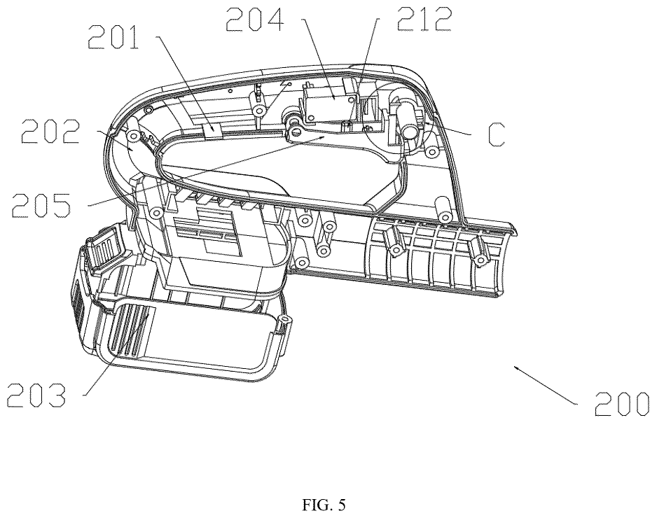

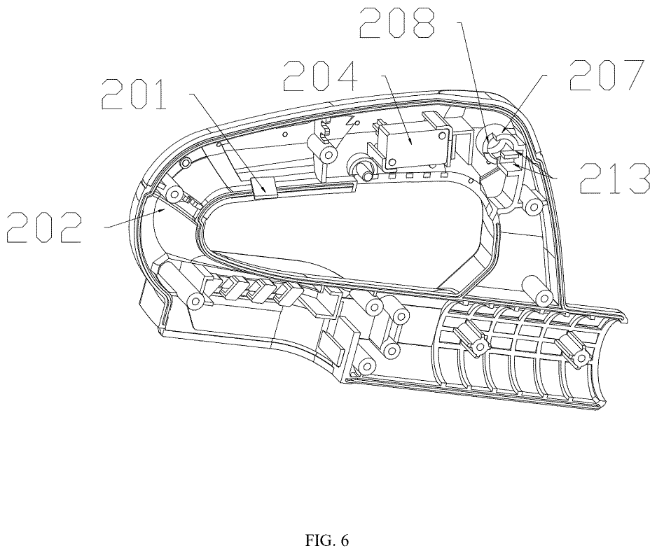

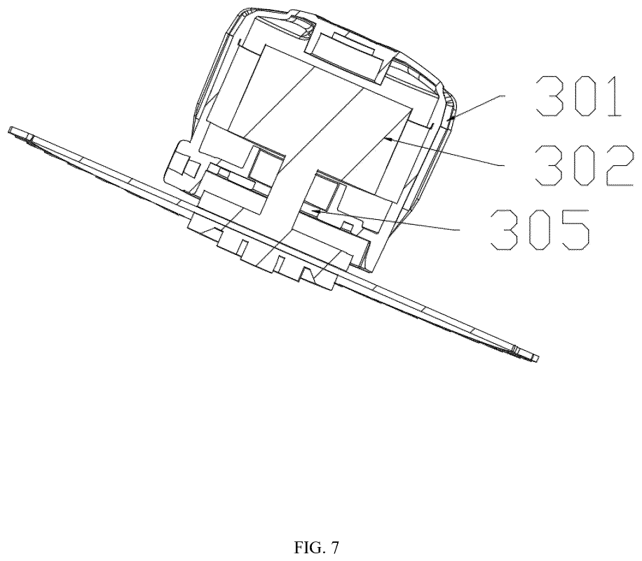

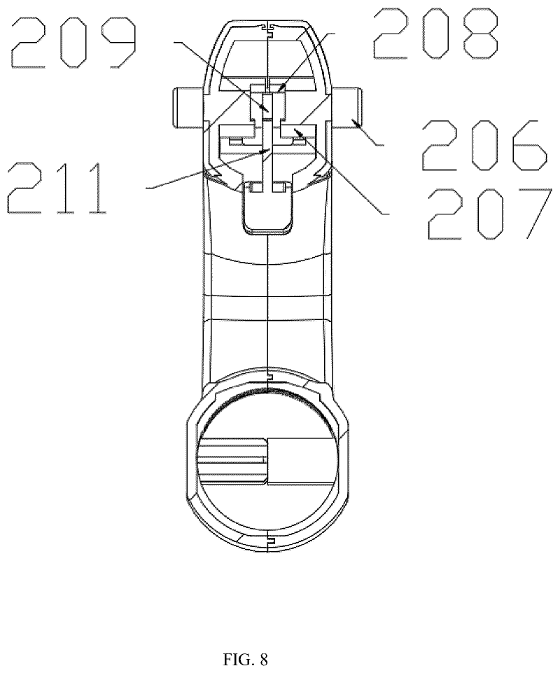

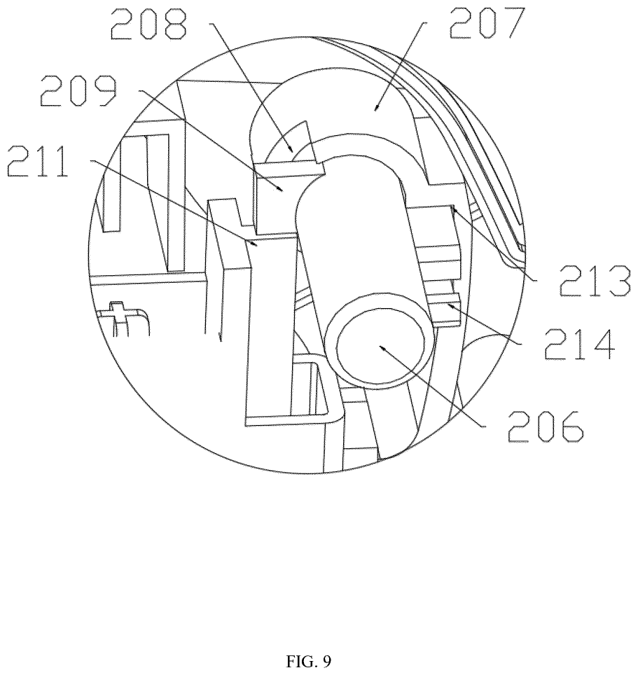

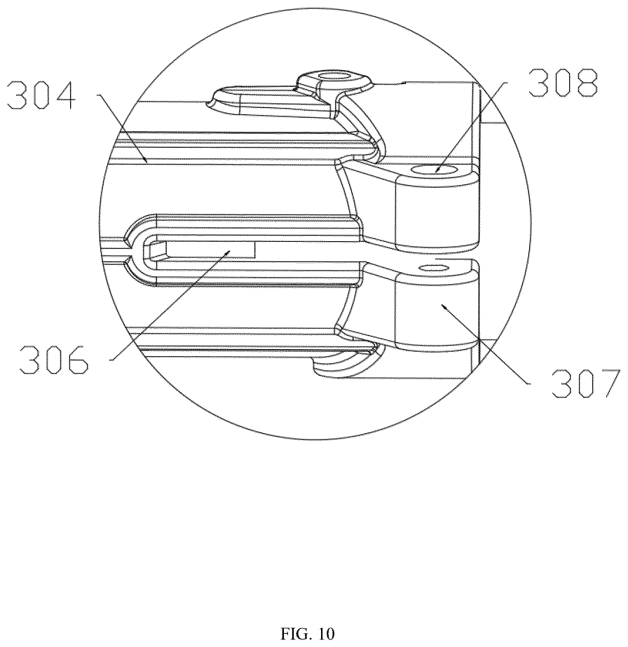

As show in FIGS. 1-10:
100. retractable operating arm,
200. handle assembly
201. control module
202. handle
203. power assembly
204. direct-acting travel switch
205. power switch
206. locking button
207. inner tube body
208. upper notch
209. limit plate
210. switch slot
211. top plate
212. contact column
213. limit slide
214. limit slide
301. housing
302. drive motor
303. cutting blade
304. connecting pipe
305. round hole
306. straight slot
307. connecting part
308. through hole

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION OF EMBODIMENTS

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

As shown in FIGS. 1-10, a lawn mower, comprising a retractable operating arm 100 and a handle assembly 200 arranged at the rear end of the retractable operating arm 100, wherein a control module 201 is arranged in the handle assembly 200, comprising a cutting assembly arranged at the front end of the retractable operating arm 100.

The cutting assembly comprises a housing 301, a driving motor 302 and a cutting blade 303. A connecting tube 304 is provided at one end of the housing 301. The connecting tube 304 is connected to the front end of the telescopic operating arm 100 to achieve a stable connection between the cutting assembly and the operating arm. A straight groove 306 and a connecting portion 307 are provided on the connecting tube 304; a driving motor 302 is provided in the housing 301, a circular hole 305 is provided at the lower end of the housing 301, a bearing is provided in the circular hole 305, a rotating shaft of the driving motor 302 extends from the bearing, and a thread is provided at the end of the rotating shaft of the driving motor 302 extending from the circular hole 305, and then the cutting blade 303 is fixed by a nut connection for easy replacement and maintenance. The driving motor 302 is responsible for providing power to drive the cutting blade 303 to rotate. The motor selection needs to consider factors such as power and speed to ensure cutting efficiency and safety.

The housing 301 is the main part of the cutting assembly, and adopts a symmetrical two-half design. After docking, a complete housing 301 is formed. The housing 301 is made of a strong and durable material to protect the internal drive motor 302 from the influence of the external environment. The contact position between the housing 301 and the drive motor 302 shaft and the bearing is sealed, and the connection position between the bearing and the circular hole 305 is sealed. In addition, the entire cutting assembly and the handle assembly 200 are waterproof, so they can be used for operations on the water surface and underwater.

The handle assembly 200 includes a handle 202, a power assembly 203, a direct-acting travel switch 204, a power switch 205, and a locking button 206. The handle 202 is arranged at the rear end of the telescopic operating arm 100. The power assembly 203 is arranged at the lower end of the handle 202 to provide power support for the entire lawn mower. An inner tube body 207 is arranged inside the upper end of the handle 202. The locking button 206 is slidably arranged in the inner tube body 207, and the two ends of the locking button 206 extend from both sides of the handle 202 respectively. An upper notch 208 is arranged at the rear end of the inner tube body 207. The locking button 206 is arranged in the middle of the rear end. A limit plate 209 is provided, and the limit plate 209 extends from the upper notch 208. A switch slot 210 is provided on the handle 202, and a power switch 205 is provided in the switch slot 210. The rear end of the power switch 205 is rotatably connected to the handle 202. A top plate 211 is provided on the upper front end of the power switch 205, and the top plate 211 cooperates with the limit plate 209. A direct-acting travel switch 204 is provided above the power switch 205 in the handle 202, and a contact column 212 is provided in the middle of the power switch 205. The contact column 212 cooperates with the direct-acting travel switch 204 to control the on and off of the power supply.

Specifically, by pressing the locking button 206 to the left or right, the locking button 206 will move along the inner tube 207, and the limit plate 209 will also move accordingly, so that the limit plate 209 and the top plate 211 on the power switch 205 are misaligned, and the limit on the top plate 211 is released. At this time, after the user pulls the power switch 205 upward, one end of the power switch 205 will rotate upward, and then the contact column 212 will be driven to move upward until the contact column 212 and the direct-acting travel switch 204 are in contact, so that the power supply of the lawn mower is connected, and the control module 201 will control the drive motor 302 to rotate, driving the cutting blade 303 to rotate to cut the grass.

When not in use, the locking button 206 should be pressed to ensure that both ends of the handle 202 are of equal length. This action connects the limit plate 209 to the top plate 211, effectively securing the top plate 211 in place. Consequently, the power switch 205 cannot be rotated, which locks it and prevents accidental activation. This safety feature enhances overall security.

A limiting groove 213 is provided on one side of the inner tube 207 in the handle 202, and the limiting groove 213 is connected to the inner tube 207. A limiting slider 214 is provided on the inner tube 207, and the limiting slider 214 and the limiting groove 213 are slidably matched, so that the inner tube 207 is limited to move in a straight line along the limiting groove 213, ensuring that the power switch 205 moves in a straight line.

The upper end of the connecting tube 304 is provided with a straight groove 306, and connecting part 307 are provided on both sides of the straight groove 306 of the connecting tube 304. The connecting part 307 is provided with a through hole 308, wherein the straight groove 306 is convenient for adjusting the opening size of the end of the connecting tube 304 to a certain extent, to facilitate the connection with the telescopic operating arm 100, and bolts can be installed in the through holes 308 on the connecting parts 307 to fasten the two connecting parts 307, thereby realizing that the connecting tube 304 is fixedly connected to the telescopic operating arm 100.

Adjust the length of the operating arm: the user can adjust the length of the retractable operating arm 100 according to the needs to adapt to working in grass of different heights, underwater and other occasions.

To unlock, press the lock button 206 either to the left or right to move the limit plate 209 and the top plate 211 on the power switch 205. This will release the limit on the top plate 211, allowing to unlock.

Start the lawn mower: The user holds the handle 202 and presses the power switch 205. The contact column 212 touches the direct-acting travel switch 204, the power is turned on, the drive motor 302 starts, and the cutting blade 303 starts to rotate.

Lock the power switch: When you need to stop using the device, you can slide the lock button 206 to make the limit plate 209 cooperate with the top plate 211 to lock the power switch 205 to prevent accidental start-up; when you need to continue using the device, you can slide the lock button 206 again to unlock it.

To maintain optimal cutting performance, replace the cutting blade 303 when it becomes worn or damaged. Unscrew the nut to easily replace the cutting blade 303.

1. A lawn mower, comprising a retractable operating arm and a handle assembly arranged at the rear end of the retractable operating arm, wherein a control module is arranged in the handle assembly, comprising a cutting assembly arranged at the front end of the retractable operating arm;
wherein the cutting assembly comprises a housing, a driving motor, and a cutting blade; a connecting tube is provided at one end of the housing; the connecting tube is connected to the front end of the retractable operating arm; a driving motor is provided in the housing; a circular hole is provided at the lower end of the housing; a bearing is provided in the circular hole; a rotating shaft of the driving motor extends from the bearing; a cutting blade is detachably provided on the rotating shaft of the driving motor extending from the circular hole; the driving motor can drive the cutting blade to rotate.

2. The lawn mower of claim 1, wherein the handle assembly comprises a handle, a power supply assembly, a direct-acting travel switch, a power switch and a locking button; the handle is arranged at the rear end of the retractable operating arm; the power supply assembly is arranged at the lower end of the handle; an inner tube body is arranged inside the upper end of the handle; the locking button is slidably arranged in the inner tube body; and two ends of the locking button extend from two sides of the handle respectively; an upper notch is arranged at the rear end of the inner tube body; and a limit plate is arranged in the middle of the rear end of the locking button, the limit plate extends from the upper notch, the handle is provided with a switch slot, a power switch is provided in the switch slot, the rear end of the power switch is rotatably connected to the handle, a top plate is provided at the upper front end of the power switch, the top plate cooperates with the limit plate, a direct-acting travel switch is provided above the power switch in the handle, a contact column is provided in the middle of the power switch, the contact column cooperates with the direct-acting travel switch to control the on and off of the power supply.

3. The lawn mower of claim 2, wherein a limiting slide groove is provided on one side of the inner tube body in the handle, the limiting slide groove is in communication with the inner tube body, a limiting slider is provided on the inner tube body, the limiting slider and the limiting slide groove are slidably matched to limit the movement of the inner tube body along the limiting slide groove.

4. The lawn mower of claim 1, wherein a straight groove is provided at the upper end of the connecting tube, connecting portions are provided on both sides of the straight groove on the connecting tube, and a through hole is provided on the connecting portion.

5. The lawn mower of claim 1, wherein the contact position between the housing and the rotating shaft of the driving motor and the bearing is sealed, and the connection position between the bearing and the circular hole is sealed.
